(19) United States
(12) Patent Application Publication
(10) Pub. No.: US 2009/0019049 A1
(43) Pub. Date: Jan. 15, 2009

(54) System and Method for Distributing Trade Signals

(76) Inventor: Marc McLean, Mentor, OH (US)

Correspondence Address: CALFEE HALTER & GRISWOLD, LLP, 800 SUPERIOR AVENUE, SUITE 1400, CLEVELAND, OH, 44114, US

(21) Appl. No.: 12/169,979

(22) Filed: Jul. 9, 2008

Related U.S. Application Data
(60) Provisional application No. 60/948,791, filed on Jul. 10, 2007.

(51) Int. Cl. G06Q 30/00; G06F 17/30; G06F 21/00

(52) U.S. Cl. 707/8; 705/1; 726/26; 707/E17.007

(57) ABSTRACT

A system and method for distributing trade signals is provided. The method includes, for example, receiving at least one trade signal from at least one trading strategy, constructing a first list of trades from the at least one trade signal, storing the list of trades in a database that is accessible through a network to specified users, comparing a second list of trades on a client computer to the first list of trades in the database, and executing the trades on the first list of trades in the database.

### CROSS-REFERENCE TO RELATED APPLICATIONS

This application claims priority to U.S. Provisional Patent Application Ser. No. 60/948,791 filed Jul. 10, 2007 and which is hereby fully incorporated by reference.

### FIELD OF THE INVENTION

The invention relates generally to data distribution, and more particularly, to systems and methods for distributing foreign currency exchange (“forex”) trade signals and related information.

Forex trading software allows individuals and others to trade foreign currencies in the forex market. Existing software platforms such as, for example, the Metatrader Online Trading Platform by MetaQuotes Software Corp., offer the ability to perform automated trading in forex markets. One component of this system is a Client Terminal. Client Terminal software allows a user to perform automated trading through the use of proprietary Expert Advisors. Proprietary Expert Advisors are software plug-ins that control the execution of the user's trades. However, Expert Advisor software residing on a Client Terminal can easily be decompiled, exposing the user's and Expert Advisor software's trading strategy. The unauthorized decompiling of Expert Advisor plug-ins or software facilitates illicit copying and use of proprietary Expert Advisors.

### SUMMARY

According to one embodiment, a method of distributing trading signals is provided. The method includes server-side software which receives trade signals from an automated or manual trading strategy. These signals and related trade information are stored in a database that is accessible from the internet or other network. The method also includes client-side software that reads the signals and trade information from the database over the internet or other network.

### BRIEF DESCRIPTION OF THE DRAWINGS

FIG. 1 is a block diagram of the various embodiments of a system and method for distributing trade signals.

FIG. 2 is a flow diagram of the various embodiments of generating and storing trade signals and related information.

FIG. 3 is a flow diagram of the various embodiments of retrieving the stored trade signals and related information.

FIG. 4 is another flow diagram of the various embodiments of generating and storing trades signals and related information.

### DETAILED DESCRIPTION OF ILLUSTRATED EMBODIMENTS

Prior to discussing the various embodiments, a review of the definitions of some exemplary terms used throughout the disclosure is appropriate. Both singular and plural forms of all terms fall within each meaning:

“Software,” as used herein, includes but is not limited to one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Related information” as used herein, means information related to a trade, including, but not limited to, for example, opening price, lot size, stoploss price, profit target price, closing price, trade type, currency pair, unique identifier, etc.

“Trade signal” as used herein means the command or communication to execute the trade. The trade signal may contain all or some or none of the related information.

“Tick” as used herein means the smallest movement of the price of a one or more currency pairs.

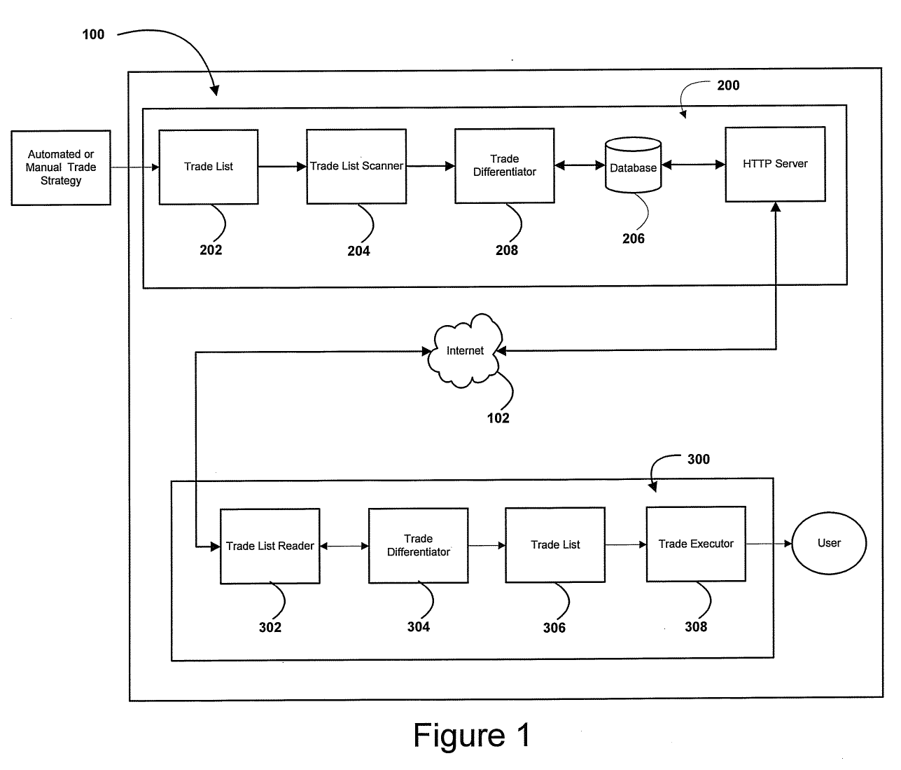

Illustrated in FIG. 1, is a block diagram of a system 100 of one embodiment of the present invention. System 100 is a client-server based system utilizing a database to store the active trades on a server. One embodiment of a server-side portion 200 of the system is shown. A trade list 202 is generated from an automatic or manual trading strategy. The trading strategy may or may not be a part of the present invention. This trade list 202 is scanned on each tick by a trade list scanner 204. The trade list 202 contains all the related information for every trade currently open on the server 100. The trade list scanner 204 reads the related information from trade list 202. The trade list 202 is compared to a database 206 by a trade differentiator 208. The trade differentiator compares the related information for each trade in the trade list 202 to the related information for each trade in the database 206. If a trade is in the trade list 202 that is not in the database 206, it is added to the database 206. If a trade is in the database 206 that is not in the trade list 202, it is removed from the database 206. The database 206 can be accessed via the Internet or other network 102 by any client 300.

One embodiment of a client side portion of the system is shown in 300. A trade list reader 302 reads the trades from database 206. These trades are compared to the trade list 306 on the client by a trade differentiator 304. Trade differentiator 304 is functionally similar to trade differentiator 208 in that they both compare the related information of trades. The source of the related information for trade differentiator 304 is the trades contained in the database. The output of trade differentiator 304 is a list of trades that should be open on the client. If a trade in the trade list 306 is not in the database 206, the trade is closed by the trade executor 308. If a trade is not in the trade list 306 but is in the database 206, the trade is opened on the client 300 by trade executor 308.

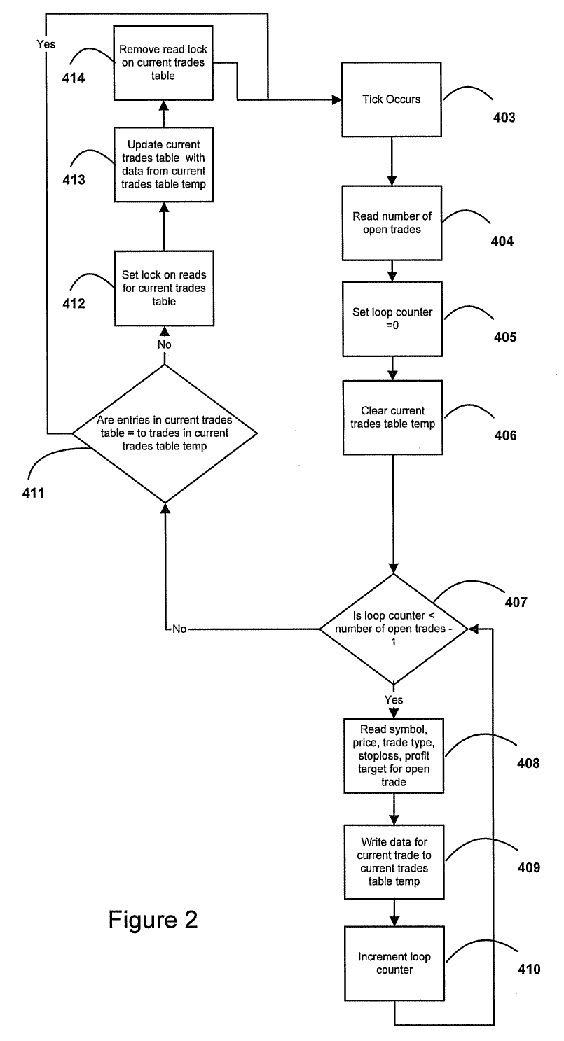

Referring now to FIG. 2, one embodiment of a flow diagram for generating a trade signal is shown. When a tick occurs in 403, the number of open trades are read as shown in 404. This number is read from an existing trading platform running on the server 200. The number of open trades determines the number of counts for the loop counter. Each count represents one open trade on the server. The loop counter is initially set to zero in 405. Thereafter, the loop counter is used to cycle through each open trade during trade related information processing that occurs in blocks 408 and 409.

After block 405, the trade related information is cleared from a temporary database table in database 206 in block 406. This is done because an open trade may have been closed or a new trade may have been opened since the last tick. This creates a temporary database table that is current as of the last tick. In particular, the trade related information for the currently open trades is cleared so the updated trade related information representing the current open trades (which may include fewer trades in the case of some open trades being closed or more trades in the case of new trades being opened) can be written to the temporary database table on every tick. If the loop counter is less than the number of open trades, as shown in 407, the trade related information for each open trade is read from the trading platform software in 408 and temporarily stored in computer memory. This information is then written to the temporary table in database 206 or stored in some other media such as computer file or computer memory as shown in 409.

The loop counter is incremented in 410 to read the next open trade's related trade information. The loop counter is then compared to the number of open trades again, in 407 to determine if the last open trade has been read. If the loop counter is equal to the number of open trades minus one, then trade related information for all the open trades has been stored, and the trade related information in the temporary table is compared to the trade related information in a current trades table in 411. In this embodiment, database 206 includes both the temporary trades table and the current trades table. The current trades table is read by the client side portion 300 in order to determine if there is a difference between the trades currently opened on the client side portion 300 and server side portion 200. If no information has changed, program execution returns to wait for the next tick to occur. If there is a difference in the trade related information contained in the temporary database table and the current trades table, a lock is set to prevent reading the current trades table as shown in 412. This is to prevent the client side portion 300 from reading the current trades table while the trade related information is being updated from the temporary trades table. This lock may be automatically imposed by the operating system or other software such as the database itself or may be generated by the present invention as shown. During this lock, the trade related information is copied from the temporary trades table to the current trades table in 413. The lock is removed in 414, so as to allow the trade related information to be read by the client side portion 300. Program execution then returns to wait for a tick to occur as shown in 403.

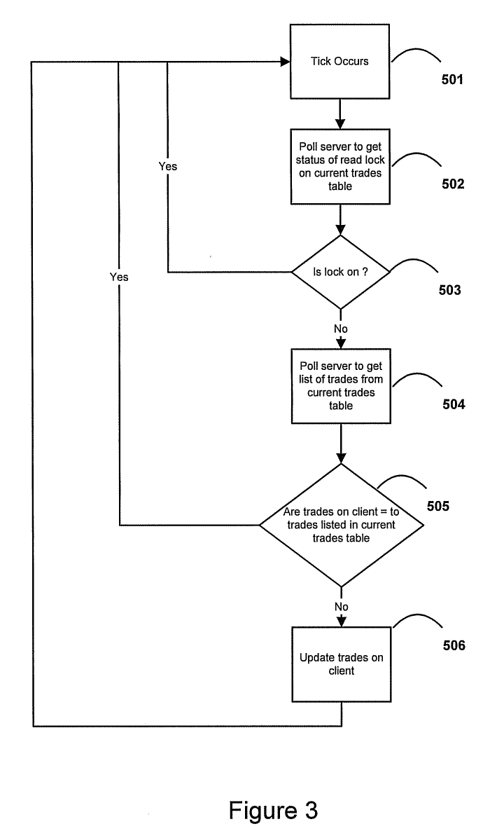

Referring now to FIG. 3, one embodiment of a flow diagram for receiving a trade signal is shown. When a tick occurs, as shown in 501, the server is polled to determine the status of the lock on the current trades table in 502. This is performed to prevent reading the trade related information while it is being updated. If the read lock is on, program execution returns to waiting for the next tick to occur as shown in 503. If the read lock is not on, the server is polled to get the trade related information for all the trades in the current trades table as shown in 504. If the related information in the current trades table read from the database 206 server is the same as the trade related information for the trades currently open on the client 300 trading platform, program execution returns to waiting for a tick to occur as shown in 505. If the trade related information in the current trades table read from the database 206 server is not the same as the trade related information for the trades currently open on the client 300 trading platform, the trades are updated as shown in 506. If a trade listed in the database 206 is not open on the client, this trade was opened since the last tick and therefore, will be opened on the client. If a trade on the client is open but is not listed in the server database 206, this trade will be closed on the client 300 trading platform. When all trades have been updated on the client 300 trading platform, program execution returns to waiting for a tick to occur as shown in 501.

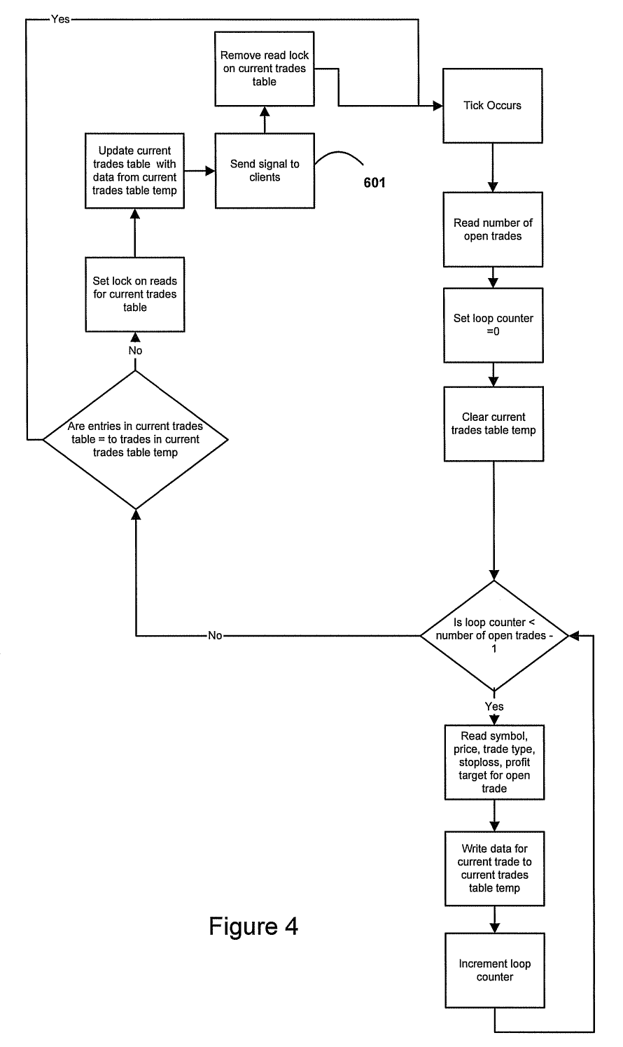

Referring now to FIG. 4, another embodiment of a flow diagram for generating a trade signal is shown. The only difference between FIG. 4 and FIG. 2 is 601. In 601, a signal is sent to clients 300 which contains the current trade's related information. This implementation is used in a signal sending architecture as opposed to a polling architecture as shown in FIG. 2.

The systems and methods of the present invention can be implemented on a variety of platforms including, for example, networked computer systems and stand-alone computer systems. Additionally, the logic and databases shown and described herein preferably reside in or on a computer readable medium such as, for example, a Read-Only Memory (ROM), Random-Access Memory (RAM), programmable read-only memory (PROM), electrically programmable read-only memory (EPROM), electrically erasable programmable read-only memory (EEPROM), magnetic disk or tape, and optically readable mediums including CD-ROM and DVD-ROM. Still further, the processes and logic described herein can be merged into one large process flow or divided into many sub-process flows. The order in which the process flows herein have been described is not critical and can be rearranged while still accomplishing the same results. Indeed, the process flows described herein may be rearranged, consolidated, and/or re-organized in their implementation as warranted or desired.

While the present invention has been illustrated by the description of embodiments thereof, and while the embodiments have been described in considerable detail, it is not the intention of the specification to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

What is claimed:

1. A method for distributing trade signals, comprising;
receiving at least one trade signal from at least one trading strategy;
constructing a first list of trades from the at least one trade signal;
storing the list of trades in a database that is accessible through a network to specified users;
comparing a second list of trades on a client computer to the first list of trades in the database; and
executing the trades on the first list of trades in the database.

2. The method of claim 1 further comprising generating a lock preventing the first list of trades in the database from being accessed by the client computer.

3. A system for providing protection from unauthorized use of a trading strategy, comprising;
at least one server having:
at least one trading strategy logic,
a first trade list,
a trade list scanner,
a first trade list differentiator, and
a database of trade information; and
at least one client having:
a trade list reader;
a second trade list differentiator;
a second trade list; and
a trade list executor.

4. The system of claim 3 further comprising logic for locking the trade list reader from accessing the database.
